(19) United States
(12) Patent Application Publication
(10) Pub. No.: US 2016/0352564 A1
(43) Pub. Date: Dec. 1, 2016

(54) METHODS AND SYSTEMS FOR PROVIDING FAILOVER AND FAILBACK IN A MULTI-NETWORK ROUTER

(71) Applicant: Japan Communications, Inc., Tokyo (JP)

(72) Inventors: Frank S. SANDA, Manhasset, NY (US); Yasushi KUDO, Marietta, GA (US); Naohisa FUKUDA, Kitasaku-gun (JP); Greg DEICKMAN, Aurora, CO (US); Kevin FRIES, Lochbule, CO (US); James Marcus WINN, Atlanta, GA (US); Brian KREWSON, Colorado Springs, CO (US); Nobuhisa YODA, Centennial, CO (US); Jonathan SOMERS, Ponte Verde, FL (US)

(21) Appl. No.: 15/233,135

(22) Filed: Aug. 10, 2016

Related U.S. Application Data
(63) Continuation of application No. PCT/US2015/015294, filed on Feb. 10, 2015.
(60) Provisional application No. 61/938,120, filed on Feb. 10, 2014.

(51) Int. Cl. H04L 12/24; H04W 76/02; H04W 48/18

(52) U.S. Cl. CPC H04L 41/0659; H04W 48/18; H04W 76/02

(57) ABSTRACT

A computer-implemented method for providing data communication between two or more host systems is provided. The method comprises designating a first network as a primary network by updating a routing table, monitoring network connections on the first network channel and a second network channel, transmitting data on the first network channel according to the routing table, detecting termination of network connection on the first network channel, determining to transmit data traffic on the first network channel, modifying the routing table, transmitting data traffic on the second network channel according to the routing table, detecting connection on the first network channel, and in response to the detection of data traffic on the first network channel, measuring a network attribute and comparing against a satisfactory threshold, and selecting the first network channel for data communication if the network attribute value satisfies the threshold.

### CROSS-REFERENCE TO RELATED APPLICATIONS

This application is a continuation application of International Application No. PCT/US2015/015294, filed on Feb. 10, 2015, which claims the benefit of U.S. Provisional Patent Application 61/938,120, filed on Feb. 10, 2014, the content of each application of which is hereby incorporated by reference in its entirety.

### BACKGROUND OF THE INVENTION

Purposes for using multiple network connections between terminals and remote servers include attaining higher network availability. A multi-network router connects terminals and servers via at least one of multiple network sessions that the router establishes with remote network components such as servers, switches or gateways. If a network connection being used for data communication fails, the multi-network router selects a network connection that is available for use at the time, and fails over the data traffic to the selected network connection.

In some multi-network routers, at least one of multiple networks is designated as a primary network. Data traffic fails over from the primary network to another network upon failure of the primary network. Such failure can be detected by monitoring the bearer network or sending data packets with the “ping” command to some remote server. When the primary network later recovers from failure, for example, upon the router determining that the bearer network as operational or the “ping” test succeeding, the router fails backs to route data through the primary network.

Stability of data communication networks is influenced by a variety of factors. In case of cellular and other radio networks, for example, these factors include the distance between a radio tower and a terminal, weather, buildings, both stationary and moving obstacles at premises, and many other conditions. Congestion due to excessive traffic with a cell as well as on the core network can also interrupt communications. Some of these interruptions can be quite prolonged, but even momentary or transitory events can disrupt digital communications, particularly if the event is repetitive.

Use of wide area data networks such as cellular wireless include data communication between ATMs (automatic teller machines) or POS (Point Of Sales) terminals and financial institutions for financial transactions among many other applications. To provide connectivity that is highly available and/or reliable, some implementations connect more than one network routers, each connecting to a cellular network. Some other implementations employ a cellular network router that contains more than one cellular network modem modules, each connecting to a cellular network. Typically, there is a routing table inside a switch that connects with one or more network routers or within a multiple-network router. When data is transmitted over a network to a remote location, the routing table can be looked up, which specifies the network through which data needs to be routed. The data can then be transmitted via the specified network interface associated with the specified network.

In case of using multiple cellular network connections to provide highly available network service, cost management becomes a significant factor in selecting which network to use primarily. Simple failover and failback of data traffic may not minimize operating costs. For example, different types of cellular networks such as, but not limited to, different generations of cellular network implementations (e.g., 2G, 3G, 4G, etc.) may have different operating costs given data traffic. In addition, cost structure of data communication may depend on how network operators procure interconnection with other telecommunication operators. In some cases, the cost is based on a monthly flat-rate per bandwidth or a variable rate per data volume. If the primary network is designated based on operating costs, it is important to maximize the use of the primary network.

A preferred network needs to be designated from both cost and network quality perspectives, and it is expected that the system maximize the use of the preferred network. Improvement on failback technology is needed to minimize the cost.

In addition, there are cases of rapid cycles of failover and failback, sometimes referred as rapid “flapping” among multiple network interfaces, occurring among multiple networks when quality level of the preferred network fluctuates just above and below the threshold level. In such a situation, it is desirable for the system not to use the preferred network until quality of the preferred network no longer fluctuates.

There has also been a need to remotely manage preferred networks, as cost structures of respective networks may change over time. The preference needs to be changed without requiring changing network selection settings at terminals such as ATMs and POS.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 depicts an embodiment of prior arts as a multi-network router with two cellular network interface modules, connecting to a server via the Internet or via a private cloud.

FIG. 2 depicts an embodiment of prior arts as a multi-network router with one LAN network interface module along with three cellular WAN interface modules.

FIG. 3 depicts exemplary computing components for implementing the present invention, according to an embodiment.

FIG. 4 depicts exemplary logical components for implementing the present invention, according to an embodiment.

FIG. 5 depicts an exemplary process for deciding data routing among multiple networks to transmit data, according to an embodiment of the invention.

### DETAILED DESCRIPTION OF THE INVENTION

The present invention discloses methods and systems provided for a multi-network router, which maintains and enforces use of a preferred network while executing failovers and failbacks among multiple networks to maximize service availability and to minimize operating costs. The multi-network router determines which network to use for data traffic, and dynamically changes the priority of available networks based on conditions of the respective networks.

According to an aspect of the present invention, a method is provided for selecting, from a plurality of networks, an optimal network through which data is to be routed. The plurality of networks may be reachable by a multi-network router as described herein. The router may be configured to perform the selection dynamically based on a variety of factors such as system or user preference (e.g., primary versus secondary network, operating costs), real-time network status (e.g., availability, traffic status, error rate, delays, latency), status report provided by an external or internal Intrusion Detection System (IDS) or module, and the like. Each of these factors may be associated with a plurality of possible weight values indicative of the relative weight or severity of the factor. The weight values for a particular network may be statically and/or dynamically assigned. Thus, for each of the plurality of networks reachable by the router, a total weight value may be calculated by combining (e.g., via multiplication) the weight values for each of the plurality of factors. The plurality of networks can then be ranked according to the calculated total weight values to determine the optimal network to route the data and the routing table associated with the router can be updated accordingly.

According to another aspect of the present invention, a method is provided for preventing route “flapping” such as described above. To this end, a dampening effect may be introduced to change the way that the routing table is updated. In particular, the dampening effect may be used to delay the update of some or all of the weight values described herein for a predetermined period of time. Additionally or alternatively, the updates may progress as scheduled, but with reduced or modified weight value for a predetermined period of time. In various embodiments, such dampening effect may be introduced for some or all of the factors at any stage in the route ranking or selection process. The length of the predetermined period of time and/or the modified weight values used within the period of time can be selected based on a variety of factors such as the duration of time since a network becomes available, the minimum and/or maximum bandwidth available on the network, an amount of data volume over the network, or other statistics or characteristics associated with the network.

Some or all aspects of the functionalities and features described herein may be implemented individually or collectively by one or more physical or logical components such as described herein.

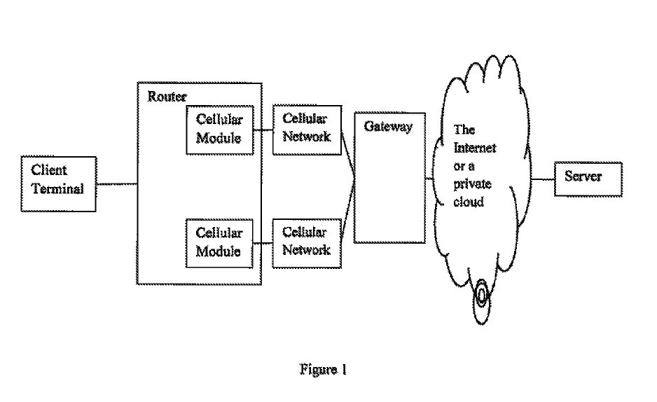

FIG. 1 depicts an embodiment of prior arts as a multi-network router with two cellular network interface modules, connecting to a server via the Internet or via a private cloud.

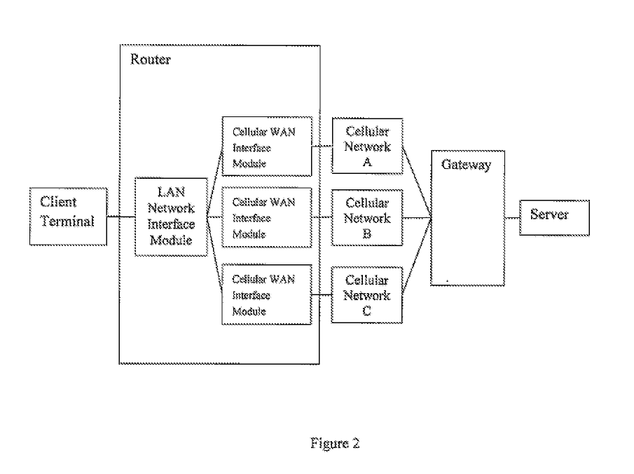

FIG. 2 depicts an embodiment of prior arts as a multi-network router with one LAN network interface module along with three cellular WAN interface modules.

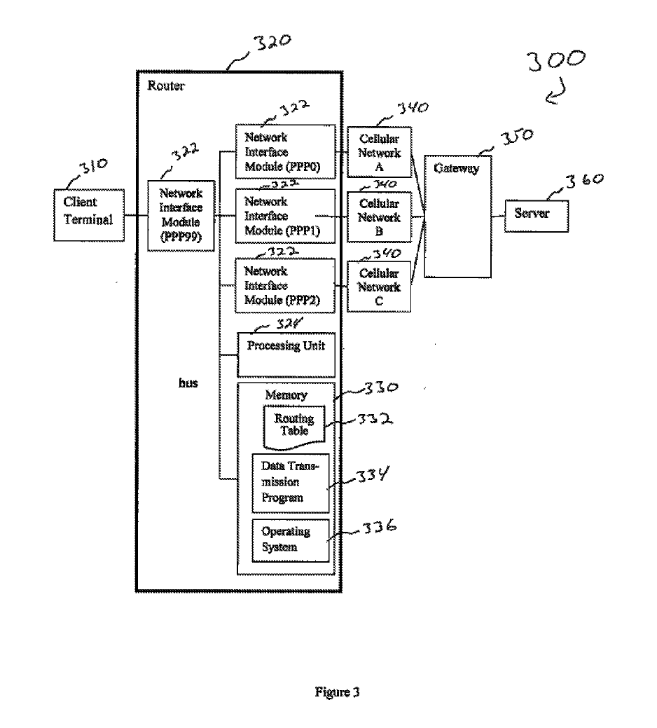

In some embodiments, such as described in FIG. 3, the invention can be implemented in a multi-network router. In particular, FIG. 3 illustrates a system 300 for communication between a client terminal and a server using a multi-network router as provided in embodiments of the present invention. FIG. 3 includes client terminal 310. Client terminal 310 of FIG. 3 represents an entity, such as an ATM or a POS terminal, which communicates with remote servers to execute financial transactions. FIG. 3 also includes a multi-network router 320. Router 320 includes network interface modules 322 referenced as “PPP99”, “PPP0”, “PPP1”, and “PPP2”. In particular, network interface module PPP99 interfaces with client terminal 310. Additionally, network interface module PPP99 interfaces with network interface modules PPP0, PPP1, and PPP2. Further, network interface modules 322 may connect with cellular networks 340. In particular, as seen in FIG. 3, network interface module PPP0 connects with cellular network A; network interface module PPP1 connects with cellular network B, and network interface module PPP2 connects with cellular network C. As shown in FIG. 3, cellular networks 340 connect to gateway 350 and gateway 350 connects to server 360. Accordingly, in this embodiment shown in FIG. 3, data traffic between client terminal 310 and server 360 can connect through at least one cellular network 340. In FIG. 3, a bus connects the network interface modules 322 with processing unit 324 and memory 330. Processing unit 324 processes computations and programs on the router 320. Memory 330 stores programs including a data transmission program 334 as well as a routing table 332 and an operating system 336. Routing table 332 may contain a list of network interfaces available for data transmission from the router 320, and may also specify over which network interface to transmit data.

Memory 330 may include a non-transitory computer readable medium or transitory computer readable medium. For example, the memory can include random access memory (“RAM”), read only memory (“ROM”), disk drive, floppy disc, tape, DVD/CD-ROM drive, memory card, USB flash drive, solid state drive (SSD) or the like. The memory can be configured to store data received from the processing unit, an input device (not shown), or other modules of the computing device. The memory may also store program code or program instructions executable by the processing unit to perform any suitable embodiments of the methods described herein. For example, the program code can include an operating system, Data Transmission Program, and the like. In some embodiments, program code may be located into Memory using a drive mechanism associated with a non-transient computer readable storage medium such as discussed above. In other embodiments, the program code may alternatively be loaded via the network interface, rather than via a non-transient computer readable storage medium.

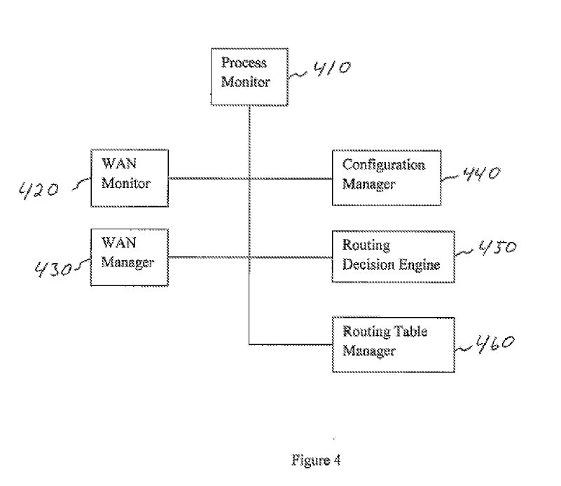

As indicated in FIG. 4, the methods and systems described herein may be implemented by the following logical components: process monitor 410, WAN monitor 420, WAN manager 430, configuration manager 440, routing decision engine 450, and routing table manager 460. In some embodiments, Process monitor 410 may manage the order that the system starts components during a boot process within the multi-network router 320. Process manager 410 may also re-start any component that has inexplicably stopped.

Additionally, a WAN monitor 420 may exist for every physical WAN interface such as an interface for a specific cellular network carrier. WAN monitor 420 monitors and determines if its assigned interface is available for transmitting and receiving data. For example, WAN monitor 410 may perform monitoring of a network for a configurable time period, such as every 10 seconds. The monitoring activity can also be triggered by an external event to start performing monitoring immediately. Further, WAN monitor 420 may feed its findings to the Routing decision engine 450.

WAN manager 430 may manage connectivity status of a WAN interface, and may reset and remedy connections when a problem occurs on network connectivity. WAN manager 430 has the ability to reinitialize and reactivate a cellular module that is associated with the cellular network. WAN manager 430 may receive interface status from an associated WAN monitor 420.

Additionally, Configuration manager 440 may accept and manage configuration attributes and their values. For example, Configuration manager 440 may maintain a list of preferred interfaces from a configuration file and produce weighted values for processing by the Routing decision engine 450.

In some embodiments, Routing decision engine 450 receives input from WAN monitors 420 and Configuration manager 440 to decide how data needs to be routed when the terminal transmits data. Routing decision engine 450 may compile and manage a list of network interfaces that are available for use based on status information from WAN monitors, such as WAN monitor 420. Routing decision engine 450 may receive input from Configuration manager 440 and compile a prioritized list of network interfaces to use for data communications. Routing decision engine 450 may use these two lists and identify a network interface that is the most desirable to use for data communication. Routing decision engine 450 may then specify this interface to the Routing table manager 460.

Routing table manager 460 may be capable of adjusting routing tables and other networking parameters. The objective of routing table manager 460 may be to route networking traffic over a singular WAN interface reported to it from the Routing decision engine 450. Routing of data may be determined based on which network the Routing table 460 specifies.

Process monitor 410 may be the first service initiated when router 320 starts. Process monitor 410 may manage the start-up of the remaining service components in router 320. The Process monitor 410 may assure that an applicable WAN monitor 420 and WAN manager 430 have been started for every interface detected. Process monitor 410 may also maintain a list of service components and their initialization sequence. Process monitor 410 may also serve as a “Watchdog” service, for example re-starting any service component that may have stopped.

WAN monitor 420 may bind to a specific interface and then attempt a connection. In order to override a possible modification on the routing table by the operating system upon its connection test, WAN monitor 420 may bypass the network interface control functionality provided by the underlying operating system and directly bind itself to the network interface port.

In some embodiments, the network connectivity tests on all network interfaces that WAN monitor 420 binds to may be repeated at a specified or unspecified interval. The test can be triggered by external services to be performed immediately. In some embodiments, the test consists of an initial verification that an IP address has been assigned to each network interface, transmission of at least one data packet to a specified network address of a remote network entity such as a remote server, and then a verification of a receipt of data by the remote entity.

WAN monitor 420 may feed test results directly to Routing decision engine 450. WAN monitor 420 may repeat feeding a status at a specified interval regardless of any change in that status. This may serve as a status heartbeat for the interface. Additionally, a network monitoring status report can be triggered by external services to perform an immediate check, rather than waiting for its next specified time.

In some embodiments, WAN monitor 420 counts and maintains status data, such as but not limited to the time duration that its network interface has been active, in order to determine the stability of network connections. WAN monitor 420 may use the time duration value to generate different weighed values depending on whether the network interface has just become active or has been active for more than a preconfigured threshold time period. By WAN monitor 420 feeding weighted values accordingly to Routing decision engine 450, the Routing decision engine 450 may effectively prevent rapid “flapping” among multiple network interfaces as the Routing decision engine 450.

In some embodiments, components other than the ones described herein may also be used to implement the present invention. In some embodiments, the components may be executed asynchronously, allowing the components to communicate with one another asynchronously. In some embodiments, the components may be executed sequentially.

The components may be implemented as a set of logics on a digital signal processor, such as an application-specific integrated circuit (ASIC), or stored on memory for execution inside a cellular router that contains one or more network modems connected to respective networks. Additionally, the components may be implemented and stored on a computer or server, which is connected to one or more network routers.

In some embodiments the invention is implemented as logic on a gate array, an application-specific integrated circuit (ASIC), or on a digital signal processor.

In some embodiments, WAN manager 430 may perform a tiered set of recovery steps against its associated interface. For example, in a first step, if a connection is down for 30 seconds an attempt may be made to reinitialize a module. In a second step, if a connection is down for an additional 30 seconds beyond the first step, an attempt may be made to re-activate the module. In a third step, if a connection is down for an additional 30 seconds beyond the second step, an attempt may be made to power down the module completely, wait a predetermined amount of time (such as 10 seconds), and then power the module back up.

Configuration manager 440 may receive external inputs on network interface preference. For example, configuration manager 440 may parse input from a discrete source, such as a configuration file, or from external intrusion detection services. Configuration manager 440 may encapsulate the specific output generated by its bound process and distill it into information usable by the system as a whole. In an example, an external service may detect a possible hacker attack on one of the network interfaces. In this example, configuration manager 440 may notify Routing decision engine 450 or WAN manager 430 that the interface in question needs to be changed in the preference hierarchy, allowing a different interface to be used for network data traffic.

Additionally, Routing decision engine 450 may compile a list of interfaces that are actively available to route traffic, based on results of network monitoring by WAN monitor 420. Routing decision engine 450 may also determine a list of the most desirable interfaces to be used for routing traffic based on a weighting algorithm, based on preference settings from Configuration manager 440. Routing decision engine 450 may pass the at least one name of the most desirable available interface to the Routing table manager 460, where the at least one name may listed on a routing table such as routing table 332.

The list of interfaces that are actively available to route traffic and/or the list of interfaces that are most desirable to be used for routing traffic may be reevaluated when Routing decision engine 450 receives new information from a Configuration manager 440 and/or when Routing decision engine 450 receives differing information from a WAN monitor 420 (e.g., a status change on an interface from “available” to “unavailable”).

A weighting algorithm that may be used to determine a list of the most desirable interfaces to be used for routing traffic may rely on “weights” being assigned to specific events and conditions. These weights may be used by configuration manager 440 and WAN monitor 420. For example, an interface that is available may be assigned a weight of “1” while an interface that is down may receive a weight of “0.” Additionally, an interface that is deemed primary may be given a weight of “1” while an interface that is deemed secondary or otherwise below primary may be given a weight that is less than 1, such as “0.5”. These weights may be used in calculating which interface is the most desirable through which to route traffic. As such, based on weighting calculations of the interfaces using a weighting algorithm, Routing decision engine 450 may specify the “winning” interface to Routing table manager 460 for updating a Routing table.

In the event that the routing decision engine 450 is unable to propose a usable interface (e.g., because no interface is listed as available), a series of steps can be taken to remedy the problem, including escalating the severity level up to the action where the Routing decision engine 450 issues a reboot of the routing device, such as router 320.

Routing table manager 460 may be implemented as a trigger-based process, activated only when it receives information from another service, such as the routing decision engine 450. The Routing table manager 460 may receive from the Routing decision engine 450 the name of the interface that traffic should be routed across. This change can be effected by modification of the Routing table 332. The routing table manager 460 may compile a proposed route table which it compares with the existing Route Table 332. If there are any differences between the two, Routing table manager 460 may replace parts of the existing table with the proposed one.

While embodiments of the present invention may be practiced utilizing multiple network interface ports, examples are provided to illustrate fail overs that may take place utilizing two network interface ports.

In a first example of the present invention, a fail over is described that takes place when a connection of a first interface port is down. In this example, a system has two interfaces: PPP0 and PPP1. A WAN monitor, such as WAN monitor 420, continuously reports the status of interfaces PPP0 and PPP1 to a Routing decision engine, such as Routing decision engine 450. Initially, both interfaces PPP0 and PPP1 are working correctly. Additionally, configuration manager 440 reads a configuration file, which contains a list of the interfaces on the system in order of preference.

In this example, the defined preference is that PPP0 is primary and PPP1 is secondary. The Configuration manager 440 translates this into a weighted list, assigning PPP0 a weighted value of 1 for being a primary interface and assigning PPP1 a weighted value of 0.5 for being a secondary interface. Further, the WAN monitor 420 determines that both interfaces PPP0 and PPP1 are up and translates this into a weighted list, assigning PPP0 and PPP1 a value of 1. The Routing decision engine 450 then takes the values from both lists, multiplies them to determine a resultant weighted value for each interface, then assesses the resultant weighted values of the interfaces to determine a most desirable interface through which to communicate data traffic. In particular, the Routing decision engine 450 may determine that the interface having the highest weighted value is the most desirable interface through which to communicate data traffic.

As the contributing weighted values for PPP0 are “1” from the configuration manager 440 and “1” from the WAN monitor 420, the resultant weighted value of PPP0 is 1×1=1. As the contributing weighted values for PPP1 are “0.5” from the configuration manager 440 and “1” from the WAN monitor 420, the resultant weighted value of PPP1 is 1×0.5=0.5.

In this example the Routing decision engine 450 may determine that the interface having the highest weighted value is the most desirable interface through which to communicate data traffic. Accordingly, the Routing decision engine 450 may initially determine that PPP0 is the most desirable interface through which to communicate data traffic in this example. The Routing decision engine 450 may report to Routing table manager 460 that interface PPP0 is the most desirable interface. In response, Routing table manager 460 may adjust a routing table, such as routing table 332, to direct pertinent traffic across PPP0.

However, in the event that PPP0 loses its connections, WAN monitor 420 may perceive the outage and send this new status to the Routing decision engine 450. Based on receiving the new status, Routing decision engine 450 may perform another calculation. In this new calculation, the weighting values assigned by configuration manager 440 may stay at “1” and “0.5” for PPP0 and PPP1, respectively, as PPP0 is considered a primary network interface. The weighting values assigned by WAN monitor 420, however, may change. In particular, WAN monitor 420 may determine that interface PPP0 is down and interface PPP1 is up and may translate this into a weighted list, assigning PPP0 a value of 0 and PPP1 a value of 1. The Routing decision engine 450 may then take the values from both lists, multiply them to determine a recalculated resultant weighted value for each interface, then assesses the resultant weighted values of the interfaces to determine a most desirable interface through which to communicate data traffic. In particular, the Routing decision engine 450 may determine that the interface having the highest weighted value is the most desirable interface through which to communicate data traffic.

As the contributing weighted values for PPP0 are “1” from the configuration manager 440 and “0” from the WAN monitor 420, the resultant weighted value of PPP0 is 1×0=0. As the contributing weighted values for PPP1 are “0.5” from the configuration manager 440 and “1” from the WAN monitor 420, the resultant weighted value of PPP1 is 1×0.5=0.5. In this example the Routing decision engine 450 may determine that the interface having the highest weighted value is the most desirable interface through which to communicate data traffic. Accordingly, the Routing decision engine 450 may determine that PPP1 is the most desirable interface through which to communicate data traffic based on the recalculated values.

The Routing decision engine 450 may report to Routing table manager 460 that interface PPP1 is the most desirable interface. In response, Routing table manager 460 may adjust a routing table, such as routing table 332, to redirect pertinent traffic from PPP0 to PPP1.

While the first example provided a description of a fail over that occurs when PPP0 becomes disconnected, a second example is provided to analyze a fail over that occurs when PPP0 regains its network connectivity. In particular, in the second example, configuration manager still has PPP0 defined as Primary, and PPP1 as Secondary. In the discussion of example 1, PPP0 was reported as down from the WAN monitor, resulting in PPP1 as having a higher resultant weighted value.

If the weights assigned to PPP1 stay the same but PPP0 begins to regain connectivity, then WAN monitor 420 may assign PPP0 a diminished value of 0.25. Even if PPP0 regains full connectivity, WAN monitor 420 may provide only a diminished value for a predetermined period of time to reflect that PPP0 has only recently regained network connectivity. If a network interface has only recently regained network connectivity, the network interface may be more likely to lose network connectivity again as the source of the network connectivity may not be fully resolved.

As such, based on the new status of PPP0 as recently regaining network connectivity (e.g., regaining network connectivity but being within a predetermined period of time after the network connectivity has been established), the Routing decision engine 450 may recalculate the weighted values of the network interfaces PPP0 and PPP1.

In this new calculation, the weighting values assigned by configuration manager 440 may stay at “1” and “0.5” for PPP0 and PPP1, respectively, as PPP0 is considered a primary network interface. The weighting values assigned by WAN monitor 420, however, may change. In particular, WAN monitor 420 may determine that interface PPP0 is recently reconnected and interface PPP1 is up and may translate this into a weighted list, assigning PPP0 a value of 0.25 and PPP1 a value of 1. The Routing decision engine 450 may then take the values from both lists, multiply them to determine a recalculated resultant weighted value for each interface, then assess the resultant weighted values of the interfaces to determine a most desirable interface through which to communicate data traffic. In particular, the Routing decision engine 450 may determine that the interface having the highest weighted value is the most desirable interface through which to communicate data traffic.

As the contributing weighted values for PPP0 are “1” from the configuration manager 440 and “0.25” from the WAN monitor 420, the resultant weighted value of PPP0 is 1×0.25=0.25. As the contributing weighted values for PPP1 are “0.5” from the configuration manager 440 and “1” from the WAN monitor 420, the resultant weighted value of PPP1 is 1×0.5=0.5. In this example the Routing decision engine 450 may determine that the interface having the highest weighted value is the most desirable interface through which to communicate data traffic. Accordingly, the Routing decision engine 450 may determine that PPP1 is the most desirable interface through which to communicate data traffic based on the recalculated values. Since the Routing decision engine 450 previously reported to Routing table manager 460 that interface PPP1 is the most desirable interface, Routing decision engine 450 may choose to not update Routing table manager 460 since there has been no change in the most desirable interface through which to communicate data traffic.

The use of assigning PPP0 a diminished value from WAN monitor 420 for a predetermined amount of time after a network connection has been re-established is used to avoid “flapping” of connections among multiple networks. In this way, if PPP0 is intermittently losing network connection, the assigning of a reduced value from WAN monitor 420 gives extra weight to the alternative interface of PPP1. Accordingly, even though the first portion of the second example provides that PPP0 has resumed a network connection, PPP1 is still the highest ranked calculation based on weighted values. As such, Routing table manager 460 maintains PPP1 as the interface for pertinent traffic while PPP0 has a diminished value assigned from WAN monitor 420.

After PPP0 has become available for data transmission and active for longer than a predetermined period of time, the WAN monitor 420 may again assign PPP0 its full value of “1” for network connectivity and report this updated status to the Routing decision engine 450. This updated status may trigger the Routing decision engine 450 to recalculate the resultant weighted values of the interfaces PPP0 and PPP1.

In this new calculation, the weighting values assigned by configuration manager 440 may stay at “1” and “0.5” for PPP0 and PPP1, respectively, as PPP0 is considered a primary network interface. The weighting values assigned by WAN monitor 420, however, may return back to the initialized values discussed in the first example where WAN monitor 420 determines that both interfaces PPP0 and PPP1 are up and assigned a value of 1.

The Routing decision engine 450 then takes the values from both lists, multiplies them to determine a recalculated resultant weighted value for each interface, then assesses the resultant weighted values of the interfaces to determine a most desirable interface through which to communicate data traffic. As the contributing weighted values for PPP0 are “1” from the configuration manager 440 and “1” from the WAN monitor 420, the resultant weighted value of PPP0 is 1×1=1. As the contributing weighted values for PPP1 are “0.5” from the configuration manager 440 and “1” from the WAN monitor 420, the resultant weighted value of PPP1 is 1×0.5=0.5. In this example the Routing decision engine 450 may determine that the interface having the highest weighted value is the most desirable interface through which to communicate data traffic. Accordingly, the Routing decision engine 450 may determine that PPP0 is the most desirable interface through which to communicate data traffic based on the recalculated values. The Routing decision engine 450 may report to Routing table manager 460 that interface PPP0 is the most desirable interface. In response, Routing table manager 460 may adjust the routing table, to redirect pertinent traffic from PPP1 to PPP0.

As discussed above, a predetermined amount of time may be set after an interface has regained connectivity before the interface is assigned a full value from the WAN monitor 420. During the predetermined amount of time, the WAN monitor 420 may assign the recently reconnected interface a diminished value. The value assigned by the WAN monitor 420 to the interface may be used in determining a resultant weighted value that is calculated by the Routing decision engine 450. However, while a threshold for keeping the recently connected interface assigned to a diminished value may be based on a predetermined amount of time, threshold for changing the interface's assigned WAN monitor 420 value from diminished to full may not be based on time—rather, or in addition, the threshold for adjusting the value of the interface may be based on a minimum or maximum bandwidth available on the network. In another example, the threshold can be based on an amount of data volume that has been transmitted to test data traffic over the newly connected network interface or the network channel since data connection over the network interface has resumed.

A third example is provided to describe how an interface may have a weighted value assigned to it demoted. For example, there may be a third-party intrusion detection program feeding configuration data to Configuration manager 440. This program may have detected a possible attack directed at interface PPP0. In response to the detection of a possible attack, the Configuration manager may translate this potential threat into a weight adjustment for PPP0, thereby demoting priority of the interface. In particular, the configuration manager 440 may adjust the preference of PPP0 from 1 to 0.1.

The configuration manager 440 may communicate the change in status of PPP0 to the Routing decision engine 450 which may then initiate recalculations based on the new status information. If the weighted values assigned to PPP0 and PPP1 from WAN monitor 420 stay at 1 each, and the weighted values assigned to PPP0 and PPP1 from configuration manager 440 are adjusted to 0.1 and 0.5, respectively, based on the potential threat of an attack on PPP0, the resultant calculated weights of PPP0 and PPP1 would be 0.1 (1×0.1=1) and 0.5 (1×0.5=0.5) respectively. As such, the Routing decision engine 450 may determine that PPP1 is the most desirable interface through which to communicate data traffic, and may provide this information to the Routing table manager 460. The Routing table manager 460 may then update the routing table accordingly.

Additionally, the configuration manager 440 may restore its full weighted value to PPP0 after a predetermined condition has been met. In particular, the configuration manager 440 may retract its demotion (in whole or in part) after a specified amount of time has passed without the configuration manager 440 receiving an indication of an attack to PPP0. The amount of time that elapses between the configuration manager 440 demoting the weighted value of PPP0 based on a potential threat and the configuration manager 440 restoring the weighted value of PPP0 based on a lack of threatening information (or, in another example, based on affirmative assurances that no attack has been detected) may vary based on a number of factors. For instance, the severity of the potential attack may affect the amount of time that the configuration manager 440 waits before restoring its full weighted value to PPP0.

While the first, second, and third examples were directed towards a system having two ports, the fourth example is directed towards a system having three ports for network interface: PPP0, PPP1, and PPP2. The WAN monitors may continuously report the status of these interfaces to the Routing decision engine. Configuration manager 440 may receive input on configuration settings from two sources: from a configuration file and from a 3rd party performance/intrusion monitor. The configuration file associated with the Configuration manager may be a simple ordered list, intended to convey interface preference. In particular, the configuration file may list the interfaces from most to least desirable. In this example, the list reads: PPP0, PPP1, PPP2. The Configuration manager 440 may translate the list into a weighted list, assigning values of 1, 0.5, and 0.25 for interfaces PPP0, PPP1, and PPP2, respectively. Further, WAN monitors may determine that all three interfaces are up, and accordingly may assign the interfaces values of 1, 1, 1 to interfaces PPP0, PPP1, and PPP2, respectively.

The Routing decision engine 450 may take the values from both lists and multiply the weighted values to determine the most desirable interface for communication data traffic. In this example, the Routing decision engine 450 may calculate resultant weighted values of 1 (1×1=1), 0.5 (0.5×1=0.5) and 0.25 (0.25×1=0.25) for interfaces PPP0, PPP1, and PPP2, respectively.

As such, in this example, the Routing decision engine 450 may determine that PPP0 is the most desirable interface to communication data traffic.

In some embodiments, a third party intrusion detection system may notice something anomalous happening on PPP0 and notify the configuration manager 440. The configuration manager may adjust the value of PPP0 accordingly by demoting the value. For example, the configuration manager may demote the value from 1 to 0.1. This change in status may be reported to the Routing decision engine 450 which may then recalculate resultant weighted values based on this change of status. If the values of the other interfaces remain the same but the value of PPP0 is changed based on the demotion from the configuration manager 440, the new resultant weighted value of PPP0 may be 0.1 (1×0.1=0.1). Based on this new calculation, the Routing decision engine 450 may determine that PPP1 having a resultant weighted value of 0.5 is the most desirable interface over which to communicate data.

In some embodiments, the WAN monitor attached to PPP1 may notice that it has lost connection. It may send this new status to the Routing decision engine, forcing another recalculation. Under the new recalculation, the WAN monitor 420 may assign weighted values of 1, 0, 1 to interfaces PPP0, PPP1, and PPP2, respectively. If the assigned weighted values from the configuration manager 440 stay the same as in the most recent example concerning a potential threat to PPP0, the recalculated weighted values are 0.1 (1×1×0.1=0.1), 0 (0×0.5=0.5), and 0.25 (1×0.25=0.25) for PPP0, PPP1, and PPP2, respectively. In this example, PPP2 has the highest value (0.25) and the Routing decision engine may report this to the Routing table manager.

In some embodiments, the network fails back to the original connection state as follows. PPP1 has regained connection. Consequently, the WAN monitor reports this status change to the Routing decision engine. In order to prevent rapid flapping of connections, however, the WAN monitor is configured to report “Reduced” functionality for a given amount of time after a connection resumes.

For example, after PPP1 establishes network connectivity, WAN monitor 420 may assign PPP1 a reduced value of 0.25. As the Routing decision engine has received new data, it may calculate the results again. In particular, WAN may assign weighted values of 1, 0.25, and 1 to PPP0, PPP1, and PPP2, respectively. If the values for the configuration manager 440 stay the same, then the resultant weighted values are 0.1 (1×1×0.1=0.1), 0.125 (0.25×0.5=0.125), and 0.25 (1×0.25=0.25) for PPP0, PPP1, and PPP2, respectively.

In this example, even though PPP1 is operational, it may be beneficial to wait a predefined amount of time before switching back to it. This is reflected by PPP2 still having the lead after the latest calculation. When that predefined amount of time has expired, PPP1 may regain its rightful place in the hierarchy.

Meanwhile, the Intrusion Detection system is no longer noticing any attacks. It has been some configurable duration since the last evidence of an attack, so the Configuration manager may revoke its demotion of PPP0. As such, configuration manager may assign weighted values of 1, 0.5, and 0.25 to interfaces PPP0, PPP1, and PPP2, respectively. If the WAN monitor weighted values assigned to the interfaces stay the same, then the newly recalculated resultant values are 1 (1×1=1), 0.125 (0.25×0.5=0.125), and 0.25 (1×0.25=0.25) for interfaces PPP0, PPP1, and PPP2, respectively. This change of status places PPP0 back as the most desirable interface over which to transmit communication data.

At a later period of time, once interface PPP1 has had network connectivity for a threshold period of time (and/or another threshold condition has been met), WAN monitor 420 may assign PPP1 a weighted value of 1 to indicate that the interface PPP1 is up. This change of status may be provided to the Router Decision Engine 450 which may recalculate weighted values. Based on the previous values, with the WAN monitor 420 may update to PPP1 from 0.25 to 1 as the only change, the recalculated values are 1, 0.5, and 0.25 for interfaces PPP0, PPP1, and PPP2, respectively. In some examples, if there is a tie in the resultant weighted values, a preference may be given to whichever interface has the higher value reported by the Configuration manager. In other examples, if there is a tie in the resultant weighted values, a preference may be given to which interface has the higher value reported by the WAN monitor. In other examples, if there is a tie in the resultant weighted values, a preference may be given to which interface has the lowest value reported by a third-party threat assessment.

In some embodiments, decision making on which network to use for data traffic may be based on integer arithmetic to minimize table look-ups, as described in further detail below. In particular, as each WAN monitor detects network connection, the WAN monitor may notify the Routing decision engine of the connection status. As the Routing decision engine receives notifications from WAN monitors, the Routing decision engine may create a link back to the WAN monitors to watch for changes. As Routing decision engine detects a change in any of the network interfaces based on notifications from WAN monitors, the Routing decision engine may re-evaluate immediately its preference list on a network interface.

Whenever WAN monitor sets or changes connection status, the status may be set in code as a string. This string may be compared to a list of known strings in the system. If the status does not exist in the list, this is considered an error. Additionally, the lists of strings that describe different statuses may be ranked from least to most desired status.

Once the status is set, the “Status” may note its order in the list and assign this as its “index.” The lower the index of a status is, the more usable the network. For example, a list of statuses may include: “Available”, “Diminished”, “Compromised”, “Startup”, “Failures in confirming connection”, and “Network Down.” Additionally, the configuration file may contain a list of all interfaces in the order of preference. As different WAN monitors register a network interface, the Routing decision engine may maintain a list of current network interfaces.

In an example, the routing decision engine may calculate a rank for each interface by first getting the index for the interfaces status (i.e. Available=0, Diminished=1, etc) and then multiplying this index by the number of interfaces present in the system. The Routing decision engine may then get the index of this interface in the preference list from the configuration file (i.e. primary=0, backup=1), and may then set this new information to the previous calculation. In this calculation, the network interface having the lowest score may be determined to be the winner.

In an example of the steps of processing, interfaces PPP0 and PPP1 may both be assigned values of 1 based on their status as being available. However, information may then be received to update PPP0 as having a diminished value. This may be reflected in PPP0 being assigned a “compromised” status. The “Compromised” status may be used to indicate when the system, such as the intrusion detection service, determines that the network interface is compromised. In examples, this algorithm may not change if additional interfaces are added. As this status list grows, the list of multipliers may grow as well, effectively eliminating the floating point calculations needed. The Routing decision engine may rank the currently connected interfaces from most preferred, to least preferred. The Routing table manager uses the results, and may set the default routes accordingly.

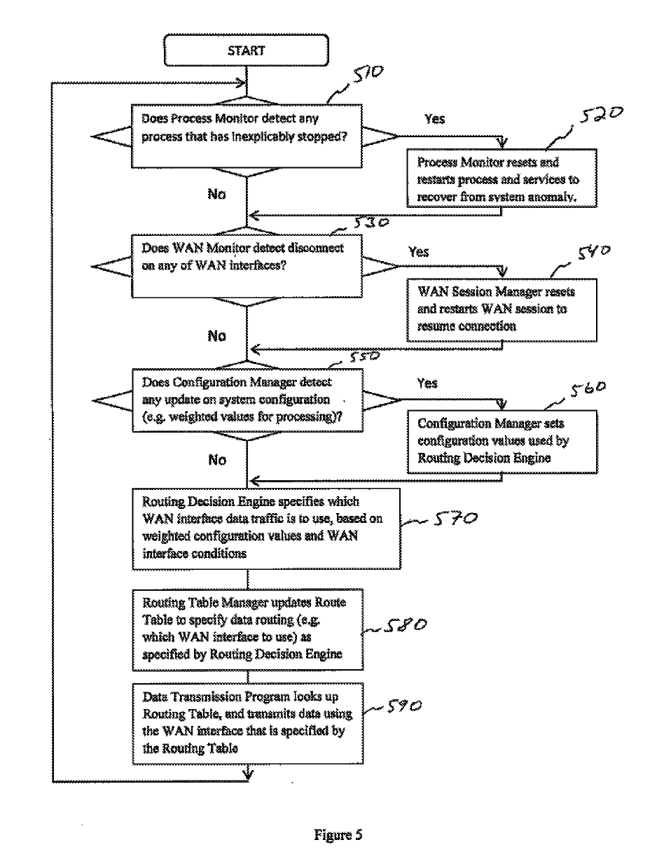

An exemplary process for deciding data routing among multiple networks to transmit data is provided in FIG. 5. As seen in FIG. 5, the exemplary process starts at block 510, where a determination is made of “Does a process monitor detect any process that has inexplicitly stopped?” If the answer to this is “Yes,” the process continues to block 520 where an action is taken such that “Process monitor resets and restarts process and services to recover from system anomaly.” After this action is completed the process moves to block 530. If the answer to block 510 is No, the process continues directly to block 530.

At block 530, a determination is made of “Does WAN monitor detect disconnect on any of WAN interfaces?” If the answer to this is “Yes,” the process continues to block 540 where an action is taken such that “WAN session manager resets and restarts WAN session to resume connection.” After this action is completed the process moves to block 550. If the answer to block 530 is No, the process moves direction to block 550.

At block 550, a determination is made of “Does Configuration manager detect any update on system configuration (e.g. weighted values for processing)?” If the answer to this is “Yes,” the process continues to block 560 where an action is taken such that “Configuration manager sets configuration values used by Routing decision engine.” After this action is completed, the process moves to block 570. If the answer to block 550 is No, the process moves directly to block 570.

At block 570, Routing decision engine specifies which WAN interface data traffic is to use, based on weighted configuration values and WAN interface conditions. Subsequently, at block 580, Routing table manager updates Route Table to specify data routing (e.g. which WAN interface to use) as specified by Routing decision engine. Subsequently, at block 590, Data Transmission Program looks up Routing table, and Transmits Data using the WAN interface that is specified by the Routing table. After block 590, the process returns to the start at block 510.

Although preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A computer-implemented method for providing data communication between two or more host systems, said method under the control of one or more computer systems configured with executable instructions and comprising:
designating a first network as a primary network by updating a routing table, monitoring network connections on the first network channel and a second network channel,
transmitting data on the first network channel according to the routing table,
detecting termination of network connection on the first network channel,
determining to transmit data traffic on the first network channel,
modifying the routing table,
transmitting data traffic on the second network channel according to the routing table,
detecting connection on the first network channel, and
in response to the detection of data traffic on the first network channel, measuring a network attribute and comparing against a satisfactory threshold, and
selecting the first network channel for data communication if the network attribute value satisfies the threshold.

2. The method of claim 1, wherein the satisfactory threshold is based on a time period since the first network channel has become available for data transmission on the first network channel.

3. The method of claim 1, wherein the satisfactory threshold is based on a minimum data bandwidth available for data transmission on the first network channel since data connection is established on the first network channel.

4. The method of claim 1, wherein the satisfactory threshold is based on a minimum amount of data volume that has been transmitted over the first network channel since data connection is established on the first network channel.
